(19) United States
(12) Patent Application Publication
(10) Pub. No.: US 2024/0020693 A1
(43) Pub. Date: Jan. 18, 2024

(54) METHOD AND SYSTEM FOR IDENTIFYING, VALIDATING AND TRANSFERING SOFT OR HARD PHYSICAL ASSET USING DIGITAL SURROGATE

(71) Applicants: SHILPA AKUNURI, FREMONT, CA (US); HANI ELMALKY, SARATOGA, CA (US); DIPANKAR ROY, CUPERTINO, CA (US)

(72) Inventors: SHILPA AKUNURI, FREMONT, CA (US); HANI ELMALKY, SARATOGA, CA (US); DIPANKAR ROY, CUPERTINO, CA (US)

(21) Appl. No.: 18/300,895

(22) Filed: Apr. 14, 2023

Related U.S. Application Data
(60) Provisional application No. 63/389,357, filed on Jul. 14, 2022.

(51) Int. Cl. G06Q 20/40; G06Q 50/18; H04L 9/32

(52) U.S. Cl. CPC G06Q 20/401; G06Q 50/18; H04L 9/3213; H04L 9/3278

(57) ABSTRACT

The embodiments herein provide a method and system for identifying, validating, and transferring soft or hard physical asset using digital surrogate. Any real-world asset is identified and traced. A digital surrogate is created in the secure distributed ledger by using NFT-based hard identifiers embedded in physical goods and by using serial number-based soft identifiers and manufacturer's identity. An original good is differentiated from a counterfeit real-world asset. The ownership of the digital surrogate is associated to an owner. The ownership of the digital surrogate is transferred to map/track the changes in ownership of the real-world asset. The identity of all assets that have a digital surrogate are stored. The ability to validate the identity of a real-world asset by comparing it with its digital surrogate smart contract in the secure distributed ledger is provided. The ability to first-time owners to associate specific immutable records to the digital surrogate is provided.

### CROSS-REFERENCE TO RELATED APPLICATIONS

The present application claims the priority from the U.S. Provisional Application with Ser. No. 63/389,357 filed on Jul. 14, 2022, with the title “METHOD AND SYSTEM FOR IDENTIFYING, VALIDATING AND TRANSFERRING SOFT OR HARD PHYSICAL ASSET USING DIGITAL SURROGATE”. The contents of the abovementioned Provisional Application are included in entirety as reference herein.

### BACKGROUND

### Technical Field

The embodiments herein relate to the field of identifying and verifying any real-world asset. The embodiments herein are particularly related to a system and method for identifying, validating, and transferring physical asset using digital surrogate. The embodiments herein are more particularly related to a method and system for identifying, validating, and transferring soft or hard physical asset by maintaining a surrogate which is a Non-Fungible Token (NFT) on a secure distributed ledger and validating using a proprietary algorithm based on soft or hard physical asset identifier.

### Description of the Related Art

Typically, a process of identifying counterfeit items is done at present by a physical observation by an expert or confirmation by the manufacturer. Also, authenticity is maintained using a physical record of ownership. However, in many cases, physical records may not exist. Additionally, there is no method or mechanism to maintain ownership of records and an asset's immutable metadata at present. However, no existing techniques exist at present for the same. Moreover, a transfer of funds conditioned on the successful transfer of ownership to a seller typically requires a platform (agent) to secure the transaction.

Hence there is a need for a method and system for uniquely identifying, validating, and transferring physical asset by maintaining a surrogate on the secure distributed ledger and validating the same using a proprietary algorithm based on soft or hard physical asset identifier. Further, there is a need for a system and method to trace the ownership of physical goods through the creation of a surrogate such as a metaobject. Still further there is a need for a system and method to prevent the theft of physical items by tying owners' identities to immutable record stores. Yet further there is a need for a system and method to validate counterfeit items. Yet there is a need for a system and method to secure a transfer of ownership of the physical asset. Yet there is a need for a system and method to maintain immutable records associated with the initial ownership record. Yet there is a need for a system and method to modify mutable records associated with the ownership records based on immutable constrained populated by different members of the ownership chain. Still, there is a need for a system and method to secure the transfer of payment against the transfer of ownership of the digital surrogate.

The above-mentioned shortcomings, disadvantages and problems are addressed herein, and which will be understood by reading and studying the following specification.

### OBJECTIVES OF THE EMBODIMENTS HEREIN

The principal object of the embodiments herein is to identify counterfeit items by identifying and validating a physical item with its digital surrogate tied to the owner to check for authenticity.

Another object of the embodiments herein is to provide a method and system for identifying, validating, and transferring soft or hard physical asset using digital surrogate by creating a Non-Fungible Token (digital surrogate) to track ownership of a real-world asset by maintaining their association on a secure distributed ledger through the life of the asset to maintain the authenticity of luxury items.

Yet another object of the embodiments herein is to identify and validate physical items with their digital surrogate tied to the owner to check for authenticity.

Yet another object of the embodiments herein is to validate the current owner of the physical asset with a digital surrogate and transfer the ownership of the digital surrogate to the new owner to maintain an owner's record.

Yet another object of the embodiments herein is to allow the first owner to populate immutable fields on the digital surrogate that will transcend potential change of ownership, for maintaining the asset's immutable metadata.

Yet another object of the embodiments herein is to create multi-party smart contracts that control the release of funds on the fulfillment of arbitrary duties agreed upon by different parties, for transferring funds on the successful transfer of ownership binding.

Yet another object of the embodiments herein is to use a non-fungible digital surrogate to track ownership of a real-world asset by maintaining their association on a secure distributed ledger through the life of the asset.

Yet another object of the embodiments herein is to validate the current owner of the physical asset with a digital surrogate and transfer the ownership of the digital surrogate to the new owner.

Yet another object of the embodiments herein is to allow the first owner to populate immutable fields on the digital surrogate that transcends a potential change of ownership.

Yet another object of the embodiment herein is to create multi-party smart contracts that condition the release of funds on the fulfillment of arbitrary duties agreed on by different parties.

Yet another object of the embodiment herein is to develop a method and system for uniquely identifying, validating, and transferring physical asset by maintaining a surrogate on the secure distributed ledger and validating the same using a proprietary algorithm based on soft or hard physical asset identifier.

Yet another object of the embodiment herein is to develop a system and method to trace the ownership of physical goods through the creation of a surrogate such as a metaobject.

Yet another object of the embodiment herein is to develop a system and method to prevent the theft of physical items by tying owners' identities to immutable record stores.

Yet another object of the embodiment herein is to develop a system and method to detect & reject counterfeit items and validate authentic items.

Yet another object of the embodiment herein is to develop a system and method to secure a transfer of ownership of the physical asset.

Yet another object of the embodiment herein is to develop a system and method to maintain immutable records associated with the initial ownership record.

Yet another object of the embodiment herein is to develop a system and method to a secure transfer of payment against the transfer of ownership of the digital surrogate.

Yet another object of the embodiment herein is to develop a system and method to modify mutable records associated with the ownership records based on immutable constraints (proes) populated by different members of the ownership chain.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide a computer-implemented method and system for identifying, validating, and transferring soft or hard physical asset using a digital surrogate. The concept of a digital surrogate on the secure distributed ledger is to maintain a unique equivalent of a real-world asset (for example a handbag). The ownership of the real-world asset is validated by an owner of a surrogate. This ownership is established by a three-way relationship between the owner, a physical asset identifier, and its digital surrogate. A change in ownership of the real-world asset is validated via a change in the ownership of the digital surrogate. This ensures that changes in ownership of an item in the real world are associated with the change of ownership of the surrogate in an immutable form on the secure distributed ledger.

According to one embodiment herein, a computer-implemented method for identifying, validating and transferring soft or hard physical asset using a digital surrogate is provided. The method comprises identifying and tracing a real-world asset, by using an immutable digital surrogate in a secure distributed ledger. The method further comprises creating a digital surrogate in the secure distributed ledger, by using an NFT (Non-Fungible Token) to embed or map to a physical cloneable function (PCF) such as serial number or physical unclonable function (PUF) such as hard identifiers and manufacturer's identity embedded in the physical goods. The NFT-based hard identifiers are created on a secure distributed ledger as a surrogate of the real-world asset and the surrogate is created only for an original asset and is owned by the owner of an original good. The PUF/PCF is mapped to the digital surrogate via an immutable ledger record. Furthermore, the method for creating the digital surrogate is provided. The method comprises initiating prose parameter collection and the prose is a self-representation in a legal matter without the benefit of legal counsel. The prose parameter collection includes specification prose and discretionary prose. The method further comprises sending a query of the specification prose including item-id to a distributed ledger network. Further, receiving the response from the distributed ledger network, and the response includes, if the specification prose, item-id is already binded with another digital surrogate, then transmitting an error message: “Error: item is already binded” and the method is halted; and if the specification prose, item-id is not binded with other digital surrogate, then an operation associating owner address with owner-id is performed. Furthermore, the method includes initiating the creation of a smart contract. The smart contract is a computer program or a transaction protocol that is intended to automatically execute, control, or document events and actions according to the terms of a contract or an agreement. Besides, releasing a token id and acknowledging the creation of the digital surrogate. Moreover, the method for identifying, validating and transferring soft or hard physical asset using digital surrogate comprises differentiating the original asset from a counterfeit real-world asset, by using the NFT or the digital surrogate mapped to the original asset through the PUF or PCF. In addition, associating the ownership of the digital surrogate to an owner, using the owner's identification as a smart contract on the secure distributed ledger. Access to the digital surrogate or NFT is provided only to the owner of the physical good. The method further includes transferring the ownership of the digital surrogate to map or track the changes in ownership of the real-world asset lifecycle. will include the transfer of ownership of the associated digital surrogate, to ensure traceability and authenticity of the ownership of the real-world asset. The method also helps to store the identity of all the real-world asset, that have a digital surrogate. In addition, the method provides the ability to validate the identity of the real-world asset, by comparing the real-world asset with the associated digital surrogate smart contract in the secure distributed ledger and also provides the ability to first-time owners to associate specific immutable records, including message, label or name to the digital surrogate.

According to one embodiment herein, the specification prose is factual attributes of the item collected from inspectors or the manufacturer's database, and the specification prose records are immutable and used to identify the item through descriptive attributes, specifications, and identifications. The specification prose includes item-id, and item-metadata TLVs (Type/Length/Value). The item-id includes PUF, which is the built-in electronic identifier stored on SOC secure enclaves, and PCF, serial number or similar cloneable identifiers. The item-metadata TLVs include a photo, 3D model, and description. Furthermore, the discretionary prose is the attributes elected at the discretion of the owner. The discretionary prose includes owner-id, mutable TLVs, 3-way mutable TLVs, and immutable TLVs. The mutable TLVs (Type/Length/Value) is muted by the current or future owners of the digital surrogate, the 3-way mutable TLVs are muted by the current and future owner only with approval from the first owner of the item and the immutable TLVs is set by the first owner and is not altered, changed, or deleted by any future owner.

According to one embodiment herein, the method uses the mapping of NFT or digital surrogate to the original asset through PUF or PCF, to identify authentic goods during the transaction time and make sure the counterfeit real-world asset can be identified by all parties prior to finalizing a transaction. The method further associates the ownership of the digital surrogate to an owner using the owner's identification as a smart contract on the secure distributed ledger. Once the real-world asset has been confirmed to be original by using the PUF/PCF (using the serial number, physical identifiers, or any other methodologies), an NFT is created as a surrogate of the real-world asset. This access to this NFT is provided only to the owner of the physical good via the present application.

According to one embodiment herein, the method further transfers the ownership of the digital surrogate to map/track the changes in ownership of the real-world asset through its life. This means that when the real-world asset item is sold, that sale will include the transfer of ownership of its digital surrogate. This will ensure traceability of the authenticity of ownership. When the real-world asset is sold and its ownership is transferred, the system will transfer the ownership of the digital surrogate to this new owner using a transfer process via an app, website, or phone call. The transfer operation will mutate the mutable records (such as current owner filed) associated to the asset's surrogate without affecting the elected immutable records of the first owner of the asset or deleting any prior ownership record chain.

According to one embodiment herein, the method stores the identity of all assets that have a digital surrogate. The method helps to retain the record of all the registered digital surrogates that represent physical assets for validation and transfer of ownership. The method further enables the owner of an asset, a potential buyer, a manufacturer, or law enforcement to look up the existence of the associated digital surrogate, by querying the physical item, PUF/PCF to establish originality and ownership.

According to one embodiment herein, the method further provides the ability to first-time owners to associate specific immutable records, such as a message, label, name, etc., to the digital surrogate. Associating specific immutable records including message, label, and name to a digital surrogate enables the owner of the real-world asset to provide all identification information needed to create the digital surrogate or NFT along with a real validation of the originality of the asset by a certifying body. As an example, a customer of a luxury bag can have specific records perpetually stored in the surrogate (e.g., labels, names, etc.) where future authenticated owners do not mutate those records without explicit approval from the original owner through the present application.

According to one embodiment herein, the changes in ownership of the real-world asset are validated via changes in ownership of the digital surrogate. Further, the changes in ownership of the real-world asset are associated with the changes in ownership of the digital surrogate in an immutable form on the secure distributed ledger.

According to one embodiment herein, the method provides transferring of ownership and validation of ownership of the digital surrogate, which is achieved through a digital surrogate validation application platform. The creation of the digital surrogate is achieved through a digital surrogate identity platform, and it uses a combination of a unique identifier on the physical goods, the manufacturer's details, the owner's identification data, and cryptography to create the digital surrogate. The digital surrogate identity platform and the digital surrogate validation application platform together constitute a digital surrogate validation platform. Every physical good/item validated by this platform will have its own identity that will provide protection against counterfeit goods. Hence, the digital surrogate validation application platform will allow merchants, consumers, and law enforcement to validate the identity of an original good versus a counterfeit. Furthermore, creates a digital surrogate (which is not a simulation) but an NFT using smart contracts on the secure distributed ledger, associates the NFT with a unique identifier of a single physical asset, leveraging the immutable properties of NFT to guarantee the originality of the physical asset, guarantee that the owner of the digital surrogate is also the owner of the physical asset and trace the physical asset by looking up the information of its digital surrogate.

According to one embodiment herein, the method is also configured to modify mutable records associated with the ownership records based on immutable constrained populated by different members of the ownership chain.

According to one embodiment herein, a computer-implemented system for identifying, validating and transferring soft or hard physical asset using digital surrogate is provided. The system comprises an oracle module configured to send authorized digital surrogate creation request in a secure distributed ledger, by using an NFT (Non-Fungible Token) based hard identifiers and serial number or physical cloneable function (PCF) or physical unclonable function (PUF) based soft identifiers and manufacturer's identity, embedded in physical goods. The NFT-based hard identifiers are created on a secure distributed ledger as a surrogate of the real-world asset and the surrogate is created only for an original asset and is owned by the owner of an original good. The PUF/PCF is mapped to the digital surrogate via an immutable ledger record. The system further comprises a frontend module configured to initiate the creation of a digital surrogate, by initiating prose parameter collection. The prose is a self-representation in a legal matter without the benefit of legal counsel. The prose parameter collection includes specification prose and discretionary prose. The system further comprises a secure node module configured to send query comprising specification prose including item-id to a distributed ledger network. The secure node is also configured to initiate a smart contract creation to the distributed ledger network. A smart contract is a computer program or a transaction protocol that is intended to automatically execute, control, or document events and actions according to the terms of a contract or an agreement. The system further comprises a secure distributed ledger module, comprising the distributed ledger network over a distributed network of compute nodes configured to create the digital surrogate and send a response to the secure node module. The response includes, if the specification prose, item-id is already binded with another digital surrogate, then transmitting an error message: “Error: item is already binded” and the method is halted, and if the specification prose, item-id is not binded with other digital surrogate, then an operation associating owner address with owner-id is performed. Further, the distributed ledger network releases a token-id to the secure node module. Further, on the creation of the digital surrogate by the secure distributed ledger module, the secure node module acknowledges the creation of the digital surrogate to the frontend module, and the frontend module acknowledges the creation of the digital surrogate to the oracle module. Furthermore, the secure distributed ledger module is further configured to differentiate the original asset from a counterfeit real-world asset, by using the NFT or the digital surrogate mapped to the original asset through the PUF or PCF. The secure distributed ledger module is also configured to associate the ownership of the digital surrogate to an owner, using the owner's identification as a smart contract on the secure distributed ledger. In addition, the secure distributed ledger module helps in transferring the ownership of the digital surrogate to map or track the changes in ownership of the real-world asset lifecycle. The secure distributed ledger module also stores the identity of all the real-world asset, that has a digital surrogate; and provides the ability to validate the identity of the real-world asset, by comparing the real-world asset with the associated digital surrogate smart contract in the secure distributed ledger. In addition, the secure distributed ledger module also provides the ability to first-time owners to associate specific immutable records, including message, label or name to the digital surrogate.

According to one embodiment herein, the specification prose is factual attributes of the item collected from inspectors or the manufacturer's database, and the specification prose records are immutable and used to identify the item through descriptive attributes, specifications, and identifications. The specification prose includes item-id, item-metadata TLVs (Type/Length/Value), and the item-id includes PUF, which is the built-in electronic identifier stored on SOC secure enclaves and PCF, serial number. The item-metadata TLVs include a photo, 3D model, and description. Furthermore, the discretionary prose is the attributes elected at the discretion of the owner. The discretionary prose includes owner-id, mutable TLVs, 3-way mutable TLVs, and immutable TLVs. The mutable TLVs (Type/Length/Value) is muted by the current or future owners of the digital surrogate, the 3-way mutable TLVs is muted by the current and future owner only with approval from the first owner of the item, and the immutable TLVs is set by the first owner and is not altered, changed, or deleted by any future owner.

According to one embodiment herein, the system uses the mapping of NFT or digital surrogate to the original asset through PUF or PCF, enabling it to identify authentic goods during the transaction time and make sure the counterfeit real-world asset can be identified by all parties prior to finalizing a transaction. The secure distributed ledger module of the system further associates the ownership of the digital surrogate to an owner using the owner's identification as a smart contract on the secure distributed ledger. Once the real-world asset has been confirmed to be original by using the PUF/PCF (using the serial number, physical identifiers, or any other methodologies), an NFT is created as a surrogate of the real-world asset. This access to this NFT is provided only to the owner of the physical good via the present application.

According to one embodiment herein, the secure distributed ledger module of the system is configured to transfer the ownership of the digital surrogate to map/track the changes in ownership of the real-world asset through its life. This means that when the real-world asset item is sold, that sale will include the transfer of ownership of its digital surrogate. This will ensure traceability of the authenticity of ownership. When the real-world asset is sold and its ownership is transferred, the system will transfer the ownership of the digital surrogate to this new owner using a transfer process via an app, website, or phone call. The transfer operation will mutate the current owner of the assets without affecting the elected immutable records of the first owner of the asset or deleting any prior ownership records.

According to one embodiment herein, the secure distributed ledger module of the system is also configured to change the ownership of the real-world asset, which is validated via changes in ownership of the digital surrogate. Further, the changes in ownership of the real-world asset are associated with the changes in ownership of the digital surrogate in an immutable form on the secure distributed ledger.

According to one embodiment herein, the secure distributed ledger module of the system is further configured to transfer the ownership and validate the ownership of the digital surrogate, which is achieved through a digital surrogate validation application platform. The creation of the digital surrogate is achieved through a digital surrogate identity platform, and it uses a combination of a unique identifier on the physical goods, the manufacturer's details, the owner's identification data, and cryptography to create the digital surrogate. The digital surrogate identity platform and the digital surrogate validation application platform together constitute a digital surrogate validation platform. Every physical good/item validated by this platform will have its own identity that will provide protection against counterfeit goods. Hence, the digital surrogate validation application platform will allow merchants, consumers, and law enforcement to validate the identity of an original good versus a counterfeit. Furthermore, creating a digital surrogate by the system, which is not a simulation, but an NFT using smart contracts on the secure distributed ledger, associates the NFT with a unique identifier of a single physical asset, leveraging the immutable properties of NFT to guarantee the originality of the physical asset, guarantee that the owner of the digital surrogate is also the owner of the physical asset and trace the physical asset by looking up the information of its digital surrogate.

According to one embodiment herein, the secure distributed ledger module of the system also stores the identity of all assets that have a digital surrogate. The secure distributed ledger module thus helps to retain the record of all the registered digital surrogates that represent physical assets for validation and transfer of ownership. The system further enables the owner of an asset, a potential buyer, a manufacturer, or law enforcement to look up the existence of the associated digital surrogate, by querying the physical item, PUF/PCF to establish originality and ownership.

According to one embodiment herein, the secure distributed ledger module is further configured to provide first-time owners to associate specific immutable records, such as a message, label, name, etc., to the digital surrogate. Associating specific immutable records including message, label, and name to a digital surrogate enables the owner of the real-world asset to provide all identification information needed to create the digital surrogate or NFT along with a real validation of the originality of the asset by a certifying body. As an example, a customer of a luxury bag can have specific records perpetually stored in the surrogate (e.g., labels, names, date codes, etc.) where future authenticated owners do not mutate those records without explicit approval from the original owner through the present application.

According to one embodiment herein, the system is also configured to modify mutable records associated with the ownership records based on immutable constrained populated by different members of the ownership chain.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart on a computer-implemented method for identifying, validating and transferring soft or hard physical asset using digital surrogate, according to one embodiment herein.

FIG. 2 illustrates an exemplary high-level decomposition of a computer-implemented system for identifying, validating and transferring soft or hard physical asset using digital surrogate, according to one embodiment herein.

FIG. 3 depicts the prose collection and surrogate creation, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In order to more clearly and concisely describe and point out the subject matter of the claimed invention, the following definitions are provided for specific terms, which are used in the following written description.

The term “PUF (Physical Unclonable Function) includes the built-in electronic identifier stored on SOC secure enclaves that can't be cloned without having access to information that are safeguarded by the original manufacturer & never shared with the pubic including the goods owners themselves

The term “PCF (Physical Cloneable Function) includes the serial number or similar identifiers that can be forged on counterfeit items

The term “surrogate” is a non-fungible token (NFT) created on distributed ledger as a representation of a physical item.

The term “ProSe” is a self-representation in a legal matter without the benefit of legal counsel. Smart contracts are broken down into multiple Proses following the Ricardian's contract format without departing from the general concept of smart contracts that follow different semantics.

The term “specification prose” is factual attributes of the item collected from inspectors or the manufacturers database. Those records are immutable and used to identify the item through descriptive attributes, specifications, and identifications.

The term “discretionary prose” includes attributes elected at the discretion of the

owner.

The term “mutable TLVs” includes Type/Length/Value that can be muted by this or future owners of the surrogate.

The term “3-way mutable TLVs” includes Type/Length/Value that can be muted by this and future owner only with approval from the first owner of the item.

The term “immutable TLVs” includes Type/Length/Value that is set by the first owner and is not altered, changed, or deleted by any future owner.

The various embodiments herein provide a computer-implemented method and system for identifying, validating, and transferring soft or hard physical asset using digital surrogate. The concept of a digital surrogate on the secure distributed ledger is to maintain a unique equivalent of a real-world asset (for example a handbag). The ownership of the real-world asset is validated by an owner of a surrogate. This ownership is established by a three-way relationship between the owner, a physical asset identifier, and its digital surrogate. A change in ownership of the real-world asset is validated via a change in the ownership of digital surrogate. This ensures that changes in ownership of an item in the real world are associated with the change of ownership of the surrogate in an immutable form on the secure distributed ledger.

According to one embodiment herein, a computer-implemented method for identifying, validating and transferring soft or hard physical asset using digital surrogate is provided. The method comprises identifying and tracing a real-world asset, by using an immutable digital surrogate in a secure distributed ledger. The method further comprises creating a digital surrogate in the secure distributed ledger, by using an NFT (Non-Fungible Token) based hard identifiers and serial number or physical cloneable function (PCF) or physical unclonable function (PUF) based soft identifiers and manufacturer's identity embedded in the physical goods. The NFT-based hard identifiers are created on a secure distributed ledger as a surrogate of the real-world asset and the surrogate is created only for an original asset and is owned by the owner of an original good. The PUF/PCF is mapped to the digital surrogate via an immutable ledger record. Furthermore, the method for creating the digital surrogate is provided. The method comprises initiating prose parameter collection and the prose is a self-representation in a legal matter without the benefit of legal counsel. The prose parameter collection includes specification prose and discretionary prose. The method further comprises sending query of the specification prose including item-id to a distributed ledger network. Further, receiving the response from the distributed ledger network, and the response includes, if the specification prose, item-id is already binded with another digital surrogate, then transmitting an error message: “Error: item is already binded” and the method is halted; and if the specification prose, item-id is not binded with other digital surrogate, then an operation associating owner address with owner-id is performed. Furthermore, the method includes initiating creation of smart contract. The smart contract is a computer program or a transaction protocol that is intended to automatically execute, control, or document events and actions according to the terms of a contract or an agreement. Besides, releasing a token id and acknowledging the creation of the digital surrogate. Moreover, the method for identifying, validating and transferring soft or hard physical asset using digital surrogate comprises differentiating the original asset from a counterfeit real-world asset, by using the NFT or the digital surrogate mapped to the original asset through the PUF or PCF. In addition, associating the ownership of the digital surrogate to an owner, using the owner's identification as a smart contract on the secure distributed ledger. The access to the digital surrogate or NFT is provided only to the owner of the physical good. The method further includes transferring the ownership of the digital surrogate to map or track the changes in ownership of the real-world asset lifecycle. The real-world asset once sold the associated sale will include the transfer of ownership of the associated digital surrogate, to ensure traceability and authenticity of the ownership of the real-world asset. The method also helps to store the identity of all the real-world asset, which have a digital surrogate. In addition, the method provides the ability to validate the identity of the real-world asset, by comparing the real-world asset with the associated digital surrogate smart contract in the secure distributed ledger and also provides the ability to first-time owners to associate specific immutable records, including message, label or name to the digital surrogate.

According to one embodiment herein, the specification prose is factual attributes of the item collected from inspectors or the manufacturer's database, and the specification prose records are immutable and used to identify the item through descriptive attributes, specifications, and identifications. The specification prose includes item-id, and item-metadata TLVs (Type/Length/Value). The item-id includes PUF, which is the built-in electronic identifier stored on SOC secure enclaves and PCF, serial number. The item-metadata TLVs include a photo, 3D model, and description. Furthermore, the discretionary prose is the attributes elected at the discretion of the owner. The discretionary prose includes owner-id, mutable TLVs, 3-way mutable TLVs, and immutable TLVs. The mutable TLVs (Type/Length/Value) are muted by the current or future owners of the digital surrogate, the 3-way mutable TLVs are muted by the current and future owner only with approval from the first owner of the item and the immutable TLVs is set by the first owner and is not altered, changed, or deleted by any future owner.

According to one embodiment herein, the method uses the mapping of NFT or digital surrogate to the original asset through PUF or PCF, to identify authentic goods during the transaction time and make sure the counterfeit real-world asset can be identified by all parties prior to finalizing a transaction. The method further associates the ownership of the digital surrogate to an owner using the owner's identification as a smart contract on the secure distributed ledger. Once the real-world asset has been confirmed to be original by using the PUF/PCF (using the serial number, physical identifiers, or any other methodologies), an NFT is created as a surrogate of the real-world asset. This access to this NFT is provided only to the owner of the physical good via the present application.

According to one embodiment herein, the method further transfers the ownership of the digital surrogate to map/track the changes in ownership of the real-world asset through its life. This means that when the real-world asset item is sold, that sale will include the transfer of ownership of its digital surrogate. This will ensure traceability of the authenticity of ownership. When the real-world asset is sold and its ownership is transferred, the system will transfer the ownership of the digital surrogate to this new owner using a transfer process via an app, website, or phone call. The transfer operation will mutate the current owner of the assets without affecting the elected immutable records of the first owner of the asset or deleting any prior ownership records.

According to one embodiment herein, the method stores the identity of all assets that have a digital surrogate. The method helps to retain the record of all the registered digital surrogates that represent physical assets for validation and transfer of ownership. The method further enables the owner of an asset, a potential buyer, a manufacturer, or a law enforcement agency to look up the existence of the associated digital surrogate, by querying the physical item, PUF/PCF to establish originality and ownership.

According to one embodiment herein, the method further provides the ability to first-time owners to associate specific immutable records, such as a message, label, name, etc., to the digital surrogate. Associating specific immutable records including message, label, and name to a digital surrogate enables the owner of the real-world asset to provide all identification information needed to create the digital surrogate or NFT along with a real validation of the originality of the asset by a certifying body. As an example, a customer of a luxury bag can have specific records perpetually stored in the surrogate (e.g., labels, names, etc.) where future authenticated owners do not mutate those records without explicit approval from the original owner through the present application.

According to one embodiment herein, the changes in ownership of the real-world asset is validated via changes in ownership of the digital surrogate. Further, the changes in ownership of the real-world asset is associated with the changes in ownership of the digital surrogate in an immutable form on the secure distributed ledger.

According to one embodiment herein, the method provides transferring of ownership and validation of ownership of the digital surrogate, which is achieved through a digital surrogate validation application platform. The creation of the digital surrogate is achieved through a digital surrogate identity platform, and it uses a combination of a unique identifier on the physical goods, the manufacturer's details, the owner's identification data, and cryptography to create the digital surrogate. The digital surrogate identity platform and the digital surrogate validation application platform together constitute a digital surrogate validation platform. Every physical good/item validated by this platform will have its own identity that will provide protection against counterfeit goods. Hence, the digital surrogate validation application platform will allow merchants, consumers, and law enforcement to validate the identity of an original good versus a counterfeit. Furthermore, creates a digital surrogate (which is not a simulation) but an NFT using smart contracts on the secure distributed ledger, associates the NFT with a unique identifier of a single physical asset, leveraging the immutable properties of NFT to guarantee the originality of the physical asset, guarantee that the owner of the digital surrogate is also the owner of the physical asset and trace the physical asset by looking up the information of its digital surrogate.

According to one embodiment herein, the method is also configured to modify mutable records associated with the ownership records based on immutable constrained populated by different members of the ownership chain.

According to one embodiment herein, a computer-implemented system for identifying, validating and transferring soft or hard physical asset using digital surrogate is provided. The system comprises an oracle module configured to send authorized digital surrogate creation request in a secure distributed ledger, by using an NFT (Non-Fungible Token) based hard identifiers and serial number or physical cloneable function (PCF) or physical unclonable function (PUF) based soft identifiers and manufacturer's identity, embedded in physical goods. The NFT-based hard identifiers are created on a secure distributed ledger as a surrogate of the real-world asset and the surrogate is created only for an original asset and is owned by the owner of an original good. The PUF/PCF is mapped to the digital surrogate via an immutable ledger record. The system further comprises a frontend module configured to initiate the creation of a digital surrogate, by initiating prose parameter collection. The prose is a self-representation in a legal matter without the benefit of legal counsel. The prose parameter collection includes specification prose and discretionary prose. The system further comprises a secure node module configured to send query comprising specification prose including item-id to a distributed ledger network. The secure node is also configured to initiate a smart contract creation to the distributed ledger network. The smart contract is a computer program or a transaction protocol that is intended to automatically execute, control, or document events and actions according to the terms of a contract or an agreement. The system further comprises a secure distributed ledger module, comprising the distributed ledger network configured to create the digital surrogate and send a response to the secure node module. The response includes, if the specification prose, item-id is already binded with another digital surrogate, then transmitting an error message: “Error: item is already binded” and the method is halted, and if the specification prose, item-id is not binded with other digital surrogate, then an operation associating owner address with owner-id is performed. Further, the distributed ledger network releases a token-id to the secure node module. Further on creation of the digital surrogate by the secure distributed ledger module, the secure node module acknowledges the creation of the digital surrogate to the frontend module, and the frontend module acknowledges the creation of the digital surrogate to the oracle module. Furthermore, the secure distributed ledger module is further configured to differentiate the original asset from a counterfeit real-world asset, by using the NFT or the digital surrogate mapped to the original asset through the PUF or PCF. The secure distributed ledger module is also configured to associate the ownership of the digital surrogate to an owner, using the owner's identification as a smart contract on the secure distributed ledger. In addition, the secure distributed ledger module helps in transferring the ownership of the digital surrogate to map or track the changes in ownership of the real-world asset lifecycle. The secure distributed ledger module also stores the identity of all the real-world asset, that has a digital surrogate; and provides the ability to validate the identity of the real-world asset, by comparing the real-world asset with the associated digital surrogate smart contract in the secure distributed ledger. In addition, the secure distributed ledger module also provides the ability to first-time owners to associate specific immutable records, including message, label or name to the digital surrogate.

According to one embodiment herein, the specification prose is factual attributes of the item collected from inspectors or the manufacturer's database, and the specification prose records are immutable and used to identify the item through descriptive attributes, specifications, and identifications. The specification prose includes item-id, item-metadata TLVs (Type/Length/Value), and the item-id includes PUF, which is the built-in electronic identifier stored on SOC secure enclaves and PCF, serial number. The item-metadata TLVs include a photo, 3D model, and description. Furthermore, the discretionary prose is the attributes elected at the discretion of the owner. The discretionary prose includes owner-id, mutable TLVs, 3-way mutable TLVs, and immutable TLVs. The mutable TLVs (Type/Length/Value) are muted by the current or future owners of the digital surrogate, the 3-way mutable TLVs are muted by the current and future owner only with approval from the first owner of the item, and the immutable TLVs is set by the first owner and is not altered, changed, or deleted by any future owner.

According to one embodiment herein, the system uses the mapping of NFT or digital surrogate to the original asset through PUF or PCF, enabling it to identify the authentic goods during the transaction time and making sure the counterfeit real-world asset can be identified by all parties prior to finalizing a transaction. The secure distributed ledger module of the system further associates the ownership of the digital surrogate to an owner using the owner's identification as a smart contract on the secure distributed ledger. Once the real-world asset has been confirmed to be original by using the PUF/PCF (using the serial number, physical identifiers, or any other methodologies), an NFT is created as a surrogate of the real-world asset. This access to this NFT is provided only to the owner of the physical good via the present application.

According to one embodiment herein, the secure distributed ledger module of the system is configured to transfer the ownership of the digital surrogate to map/track the changes in ownership of the real-world asset through its life. This means that when the real-world asset item is sold, that sale will include the transfer of ownership of its digital surrogate. This will ensure traceability of the authenticity of ownership. When the real-world asset is sold and its ownership is transferred, the system will transfer the ownership of the digital surrogate to this new owner using a transfer process via an app, website, or phone call. The transfer operation will mutate the current owner of the assets without affecting the elected immutable records of the first owner of the asset or deleting any prior ownership records.

According to one embodiment herein, the secure distributed ledger module of the system is also configured to change the ownership of the real-world asset, which is validated via changes in ownership of the digital surrogate. Further, the changes in ownership of the real-world asset are associated with the changes in ownership of the digital surrogate in an immutable form on the secure distributed ledger.

According to one embodiment herein, the secure distributed ledger module of the system is further configured to transfer the ownership and validate the ownership of the digital surrogate, which is achieved through a digital surrogate validation application platform. The creation of the digital surrogate is achieved through a digital surrogate identity platform, and it uses a combination of a unique identifier on the physical goods, the manufacturer's details, the owner's identification data, and cryptography to create the digital surrogate. The digital surrogate identity platform and the digital surrogate validation application platform together constitute a digital surrogate validation platform. Every physical good/item validated by this platform will have its own identity that will provide protection against counterfeit goods. Hence, the digital surrogate validation application platform will allow merchants, consumers, and law enforcement to validate the identity of an original good versus a counterfeit. Furthermore, creating a digital surrogate by the system, which is not a simulation, but a NFT using smart contracts on the secure distributed ledger, associates the NFT with a unique identifier of a single physical asset, leveraging the immutable properties of NFT to guarantee the originality of the physical asset, guarantee that the owner of the digital surrogate is also the owner of the physical asset and trace the physical asset by looking up the information of its digital surrogate.

According to one embodiment herein, the secure distributed ledger module of the system also stores the identity of all assets that have a digital surrogate. The secure distributed ledger module thus helps to retain the record of all the registered digital surrogates, which represent physical assets for validation and transfer of ownership. The system further enables the owner of an asset, a potential buyer, a manufacturer, or law enforcement to look up the existence of the associated digital surrogate, by querying the physical item, PUF/PCF to establish originality and ownership.

According to one embodiment herein, the secure distributed ledger module is further configured to provide first-time owners to associate specific immutable records, such as a message, label, name, etc., to the digital surrogate. Associating specific immutable records including message, label, and name to a digital surrogate enables the owner of the real-world asset to provide all identification information needed to create the digital surrogate or NFT along with a real validation of the originality of the asset by a certifying body. As an example, a customer of a luxury bag can have specific records perpetually stored in the surrogate (e.g., labels, names, etc.) where future authenticated owners do not mutate those records without another explicit approval from the original owner through the present application.

According to one embodiment herein, the system is also configured to modify mutable records associated with the ownership records based on immutable constrained populated by different members of the ownership chain.

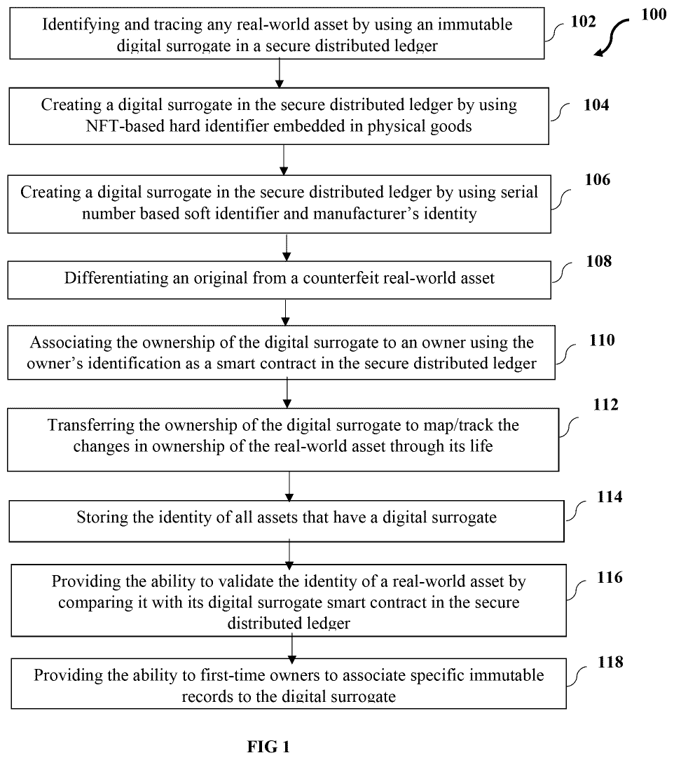

FIG. 1 illustrates a flowchart on a computer-implemented method for identifying, validating and transferring soft or hard physical asset using digital surrogate, according to one embodiment herein. The method 100 comprises at step 102, identifying and tracing any real-world asset by using an immutable digital surrogate in the secure distributed ledger. At step 104, creating a digital surrogate in the secure distributed ledger by using NFC -based hard identifiers embedded in physical goods. At step 106, method 100 includes creating a digital surrogate in the secure distributed ledger by using serial number-based soft identifiers and manufacturer's identity. Further, at step 108, differentiating an original good from a counterfeit real-world asset. At step 110, method 100 involves associating the ownership of the digital surrogate to an owner using the owner's identification as a smart contract on the secure distributed ledger. Then, at step 112, method 100 involves transferring the ownership of the digital surrogate to map/track the changes in ownership of the real-world asset through its life. Furthermore, at step 114, method 100 involves storing the identity of all assets that have a digital surrogate. At step 116, providing the ability to validate the identity of a real-world asset by comparing it with its digital surrogate smart contract in the secure distributed ledger is provided. Finally, at step 118, method 100 involves providing the ability to first-time owners to associate specific immutable records (e.g., a message, label, name) to the digital surrogate.

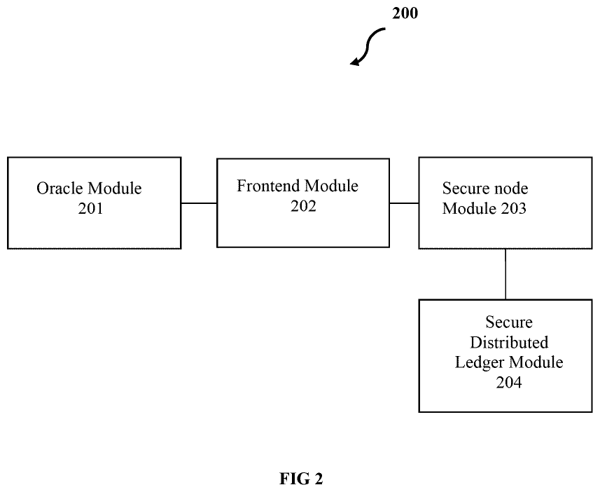

FIG. 2 illustrates an exemplary high-level decomposition of a computer-implemented system for identifying, validating and transferring soft or hard physical asset using digital surrogate, according to one embodiment herein. In an embodiment, the system 200 comprises an oracle module 201 configured to send authorized digital surrogate creation request in a secure distributed ledger, by using an NFT (Non-Fungible Token) based hard identifiers and serial number or physical cloneable function (PCF) or physical unclonable function (PUF) based soft identifiers and manufacturer's identity, embedded in physical goods. The NFT-based hard identifiers are created on a secure distributed ledger as a surrogate of the real-world asset and the surrogate is created only for an original asset and is owned by the owner of an original good. The PUF/PCF is mapped to the digital surrogate via an immutable ledger record. The system 200 further comprises a frontend module 202 configured to initiate the creation of a digital surrogate, by initiating prose parameter collection. The prose is a self-representation in a legal matter without the benefit of legal counsel. The prose parameter collection includes specification prose and discretionary prose. The system 200 further comprises a secure node module 203 configured to send query comprising specification prose including item-id to a distributed ledger network. The secure node is also configured to initiate a smart contract creation to the distributed ledger. A smart contract is a computer program or a transaction protocol that is intended to automatically execute, control, or document events and actions according to the terms of a contract or an agreement. The system 200 further comprises a secure distributed ledger module 204, comprising the distributed ledger network configured to create the digital surrogate and send a response to the secure node module. The response includes, if the specification prose, item-id is already binded with another digital surrogate, then transmitting an error message: “Error: item is already binded” and the method is halted, and if the specification prose, item-id is not binded with other digital surrogate, then an operation associating owner address with owner-id is performed. Further, the distributed ledger network releases a token-id to the secure node module 203. Further, on the creation of the digital surrogate by the secure distributed ledger module 204, the secure node module 203 acknowledges the creation of the digital surrogate to front end module 202, and the frontend module 202 acknowledges the creation of the digital surrogate to the oracle module 201. Furthermore, the secure distributed ledger module 204 is configured to differentiate the original asset from a counterfeit real-world asset, by using the NFT or the digital surrogate mapped to the original asset through the PUF or PCF. The secure distributed ledger module 204 is also configured to associate the ownership of the digital surrogate to an owner, using the owner's identification as a smart contract on the secure distributed ledger. In addition, the secure distributed ledger module 204 helps in transferring the ownership of the digital surrogate to map or track the changes in ownership of the real-world asset lifecycle. The secure distributed ledger module 204 also stores the identity of all the real-world asset, that has a digital surrogate; and provides the ability to validate the identity of the real-world asset, by comparing the real-world asset with the associated digital surrogate smart contract in the secure distributed ledger. In addition, the secure distributed ledger module 204 also provides the ability to first-time owners to associate specific immutable records, including message, label or name to the digital surrogate.

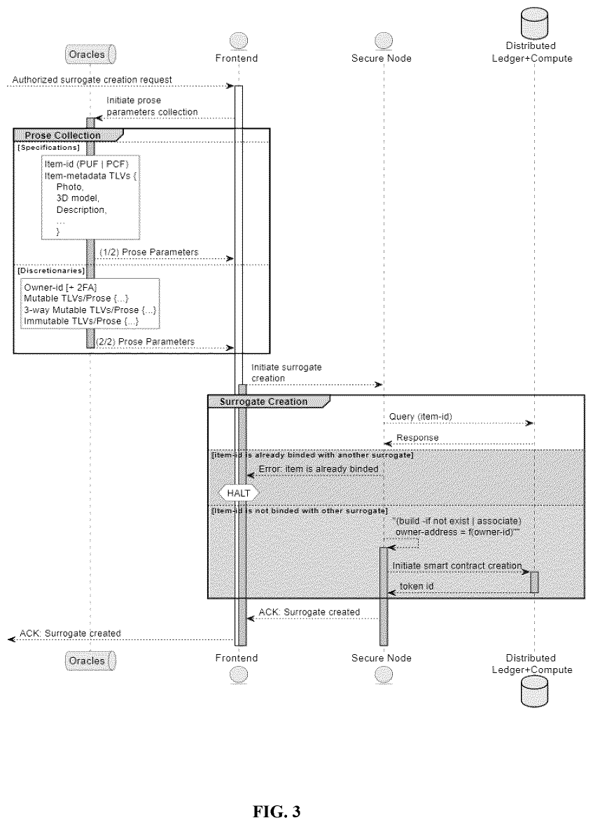

FIG. 3 depicts the prose collection and surrogate creation, according to an embodiment herein. FIG. 3, illustrates an oracle module or oracles, which is configured to send authorized surrogate creation request to a frontend module. The frontend module initiates prose parameters collection. The “Prose” is a self-representation in a legal matter without the benefit of legal counsel. Smart contracts are broken down into multiple Proses following Ricardian's contract format. The prose collection includes specification prose and discretionary prose. The specification prose includes item-id and item-metadata TLVs. The item-id includes Physical Unclonable Function (PUF) which is the built-in electronic identifier stored on SOC secure enclaves and Physical Cloneable Function (PCF) (e.g., serial number). The item-metadata TLVs include a photo, 3D model, description, etc. The specification prose is factual attributes of the item collected from inspectors or the manufacturer's database. Those records are immutable and used to identify the item through descriptive attributes, specifications, and identifications. The discretionary prose is the attributes elected at the discretion of the owner. The discretionary prose includes owner-id, mutable TLVs, 3-way mutable TLVs, and immutable TLVs. In the mutable TLVs Type/Length/Value is muted by this or future owners of the surrogate. In 3-way mutable TLVs Type/Length/Value is muted by this and future owners only with approval from the first owner of the item. In immutable TLVs Type/Length/Value is set by the first owner and is not altered, changed, or deleted by any future owner. Furthermore, the surrogate creation as depicted in FIG. 3, the surrogate is a Non-Fungible token (NFT) created on the secure distributed ledger as a representation of a physical item. The frontend module initiates surrogate creation to a secure node module. The secure node module further sends query of item-id to distribute ledger network, and the distributed ledger network sends the response to the secure node module. If item-id is already binded with another surrogate, then it is represented as “Error: item is already binded” and it is halted. If item-id is not binded with other surrogate, then operation “(build-if not exist|associate) owner-address=f(owner-id)” is performed. In addition, the secure node module initiates a smart contract creation to distributed ledger network. The distributed ledger network releases the token id to the secure node module. Furthermore, the secure node module acknowledges created surrogate to the frontend module, and the frontend module acknowledges created surrogate to the oracle module or oracles.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however, that it is not intended to limit the disclosure to the forms disclosed, but on the contrary, the disclosure is to cover all modifications, equivalents, and alternatives falling within the scope of the disclosure.

### ADVANTAGES OF THE EMBODIMENTS HEREIN

The embodiments herein disclose a computer-implemented system and method for identifying, validating, and transferring soft or hard physical asset using digital surrogate. The technical advantages envisaged by the embodiment herein include tracing the ownership of physical goods through the creation of a surrogate (i.e., a metaobject). The embodiment herein, prevents the theft of physical items by tying owners' identities to immutable record stores. The embodiment herein also validates against counterfeit items and secures transfer of ownership. It maintains immutable records associated with the initial ownership record. Furthermore, the embodiment herein also secures transfer of payment against the transfer of ownership of the digital surrogate.

In addition, the embodiment herein helps to identify and validate physical item with its digital surrogate tied to the owner to check for authenticity. The embodiment herein, uses a non-fungible digital surrogate to track ownership of a real-world asset by maintaining their association on a secure distributed ledger through the life of the asset. It also validates the current owner of the physical asset with a digital surrogate and transfer the ownership of the digital surrogate to the new owner. Moreover, the embodiment herein, allows the first owner to populate immutable fields on the digital surrogate that will transcend potential change of ownership. The embodiments herein further provides multi-party smart contracts that control or manage the release of funds on the fulfillment of arbitrary duties agreed on by different parties.

In addition, the embodiment herein creates a Non-Fungible Token (NFT) on a secure distributed ledger as a surrogate of the real-world asset. The surrogate is created only for an original asset and is owned by the owner of the original good. This suggests that the physical asset is to be built with a Physical Unclonable Function (PUF) (e.g., the built-in electronic identifier stored on SOC secure enclaves). The PUFs are mapped to the surrogate via an immutable ledger entry. The physical good created with Physical Cloneable Function (PCF) (e.g., serial number) gets identified via mapping the PCF with a surrogate (i.e., NFT) via an immutable ledger record. Now there is an NFT (i.e., Surrogate) mapped to the original asset through a PUF or PCF. The embodiment herein uses this mapping to identify authentic goods during the transaction time and ensure that a counterfeit item is identified by all parties prior to finalizing the transaction. Once the physical asset is confirmed to be original by using the PUF/PCF (Using serial number, physical identifiers, or any other methodologies), an NFT is created as a surrogate of the real-world asset. This access to this NFT is provided only to the owner of the physical goods via our application.

Furthermore, the embodiment herein provides an onboarding method for the owner of a physical asset to provide all identification information needed to create the surrogate NFT along with a real validation of the originality of the asset by a certifying body. As an example, an owner of a luxury bag is provided with specific records perpetually stored in the surrogate (e.g., labels, names, etc.) where the future or newly authenticated owners do not mutate those records without explicit approval from the original owner through our application.

Hence, the embodiment herein provides an end-to-end framework for not only performing the transaction but also providing means for both parties to confirm the authenticity of the physical item, collect compensation in escrow during the transaction fulfillment, and enforce future mutable & immutable fields on the digital surrogate that can survive multiple future transactions and not only the current transaction. Furthermore, the embodiment herein provides a framework, and combines it with smart contracts and NFTs to enable multiple parties to define mutable and immutable fields associated with the physical item that can be tracked through the lifetime of the asset, and transcend the change of ownership, and used to validate its authenticity in the real world.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer-implemented method (100) for identifying, validating, and transferring soft or hard physical asset using digital surrogate, comprising the steps of:
a. identifying and tracing a real-world asset, by using an immutable digital surrogate in a secure distributed ledger (102);
b. creating a digital surrogate in the secure distributed ledger, by using an NFT (Non-Fungible Token) based hard identifiers (104) and serial number or physical cloneable function (PCF) or physical unclonable function (PUF) based soft identifiers and manufacturer's identity embedded in the physical goods (106);
and wherein the NFT-based hard identifiers are created on a secure distributed ledger as a surrogate of the real-world asset; and wherein the surrogate is created only for an original asset, and is owned by the owner of an original good; and wherein the PUF/PCF is mapped to the digital surrogate via an immutable ledger record; and wherein the method for creating the digital surrogate, comprises the step of:
i. initiating prose parameter collection; wherein the prose is a self-representation in a legal matter without the benefit of legal counsel; and wherein the prose parameter collection includes specification prose and discretionary prose;
ii. sending query of the specification prose including item-id to a distributed ledger network;
iii. receiving the response from the distributed ledger network; and wherein the response includes, if the specification prose, item-id is already binded with another digital surrogate, then transmitting an error message: “Error: item is already binded” and the method is halted; and wherein if the specification prose, item-id is not binded with other digital surrogate, then an operation associating owner address with owner-id is performed;
iv. initiating the creation of a smart contract; and wherein the smart contract is a computer program or a transaction protocol that is intended to automatically execute, control or document events and actions according to the terms of a contract or an agreement;
v. releasing a token id and acknowledging the creation of the digital surrogate;
c. differentiating the original asset from a counterfeit real-world asset, by using the NFT or the digital surrogate mapped to the original asset through the PUF or PCF (108);
d. associating the ownership of the digital surrogate to an owner, using the owner's identification as a smart contract on the secure distributed ledger (110); and
wherein the access to the digital surrogate or NFT is provided only to the owner of the physical good;
e. transferring the ownership of the digital surrogate to map or track the changes in ownership of the real-world asset lifecycle (112); and wherein the real-world asset, once sold the associated sale will include the transfer of ownership of the associated digital surrogate, to ensure traceability and authenticity of the ownership of the real-world asset;
f. storing the identity of all the real-world asset, that have a digital surrogate (114);
g. providing the ability to validate the identity of the real-world asset, by comparing the real-world asset with the associated digital surrogate smart contract in the secure distributed ledger (116); and
h. providing the ability to first-time owners to associate specific immutable records, including message, label or name to the digital surrogate (118);

2. The method (100) according to claim 1, wherein the specification prose is factual attributes of the item collected from inspectors or the manufacturer's database, and the specification prose records are immutable and used to identify the item through descriptive attributes, specifications, and identifications; and wherein the specification prose includes item-id, item-metadata TLVs (Type/Length/Value); and wherein the item-id includes PUF, that is the built-in electronic identifier stored on SOC secure enclaves and PCF, serial number; and wherein the item-metadata TLVs includes photo, 3D model, description; wherein the discretionary prose are the attributes elected at the discretion of the owner; and wherein the discretionary prose includes owner-id, mutable TLVs, 3-way mutable TLVs and immutable TLVs; and wherein the mutable TLVs (Type/Length/Value) is muted by the current or future owners of the digital surrogate; and wherein the 3-way mutable TLVs is muted by the current and future owner only with approval from the first owner of the item; and wherein the immutable TLVs is set by the first owner and is not altered, changed, or deleted by any future owner.

3. The method (100) according to claim 1, comprises using the mapping of NFT or digital surrogate to the original asset through PUF or PCF, to identify authentic goods during the transaction time and make sure the counterfeit real-world asset can be identified by all parties prior to finalizing a transaction.

4. The method (100) according to claim 1, wherein the real-world asset once sold to a new owner, then the associated ownership of the digital surrogate is also transferred to the new owner; and wherein the transfer of ownership of the digital surrogate to the new owner is processed through an application, website or a phone call; and wherein the transfer of ownership to the new owner will mutate the current owner of the assets without affecting immutable records of the first owner of the real-world asset or deleting any prior ownership records.

5. The method (100) according to claim 1 comprises retaining the record of all registered digital surrogate, which represent physical assets for validation and transfer of ownership.

6. The method (100) according to claim 1, comprises enabling the owner of an asset, a potential buyer, a manufacturer, or a law enforcement to look up the existence of the associated digital surrogate, by querying the physical item, PUF/PCF to establish originality and ownership.

7. The method (100) according to claim 1, wherein the associating specific immutable records including message, label, name to a digital surrogate enables the owner of the real-world asset to provide all identification information needed to create the digital surrogate or NFT along with a real validation of the originality of the asset by a certifying body.

8. The method (100) according to claim 1, wherein the changes in ownership of the real-world asset are validated via changes in ownership of the digital surrogate; and wherein the changes in ownership of the real-world asset is associated with the changes in ownership of the digital surrogate in an immutable form on the secure distributed ledger.

9. The method (100) according to claim 1, wherein the transferring of ownership and validation of ownership of the digital surrogate is achieved through a digital surrogate validation application platform; and wherein the creation of the digital surrogate is achieved through a digital surrogate identity platform; and wherein the digital surrogate identity platform uses a combination of a unique identifier on the physical goods, manufacturer's details, the owner's identification data, and cryptography to create the digital surrogate; and wherein the digital surrogate identity platform and the digital surrogate validation application platform together constitutes a digital surrogate validation platform; and wherein the digital surrogate validation application platform allows the merchants, consumers, and law enforcement to validate the identity of an original good versus a counterfeit.

10. The method (100) according to claim 1, wherein the method (100) is further configured to modify mutable records associated with the ownership records based on immutable constrained populated by different members of the ownership chain.

11. A computer-implemented system (200) for identifying, validating, and transferring soft or hard physical asset using digital surrogate comprising:
a. an oracle module (201) configured to send authorized digital surrogate creation request in a secure distributed ledger, by using an NFT (Non-Fungible Token) based hard identifiers and serial number or physical cloneable function (PCF) or physical unclonable function (PUF) based soft identifiers and manufacturer's identity, embedded in physical goods; and wherein the NFT-based hard identifiers are created on a secure distributed ledger as a surrogate of the real-world asset; and wherein the surrogate is created only for an original asset, and is owned by the owner of an original good; and wherein the PUF/PCF is mapped to the digital surrogate via an immutable ledger record;
b. a frontend module (202) configured to initiate the creation of a digital surrogate, by initiating prose parameter collection; and wherein the prose is a self-representation in a legal matter without the benefit of legal counsel; and wherein the prose parameter collection includes specification prose and discretionary prose;
c. a secure node module (203) configured to send query comprising specification prose including item-id to a distributed ledger network; and wherein the secure node is also configured to initiate a smart contract creation to the distributed ledger network;
d. a secure distributed ledger module (204), comprising the distributed ledger network configured to create the digital surrogate and send response to the secure node module; and wherein the response includes, if the specification prose, item-id is already binded with another digital surrogate, then transmitting an error message: “Error: item is already binded” and the method is halted; and wherein if the specification prose, item-id is not binded with other digital surrogate, then an operation associating owner address with owner-id is performed; and wherein the distributed ledger network releases a token-id to the secure node module; and
wherein on creation of the digital surrogate by the secure distributed ledger module, the secure node module acknowledges the creation of the digital surrogate to front end module; and wherein the frontend module acknowledges the creation of the digital surrogate to the oracle module; and wherein the secure distributed ledger module is further configured to differentiate the original asset from a counterfeit real-world asset, by using the NFT or the digital surrogate mapped to the original asset through the PUF or PCF; associate the ownership of the digital surrogate to an owner, using the owner's identification as a smart contract on the secure distributed ledger; transfer the ownership of the digital surrogate to map or track the changes in ownership of the real-world asset lifecycle; store the identity of all the real-world asset, that have a digital surrogate; provide the ability to validate the identity of the real-world asset, by comparing the real-world asset with the associated digital surrogate smart contract in the secure distributed ledger; and provide the ability to first-time owners to associate specific immutable records, including message, label or name to the digital surrogate.

12. The system (200) according to claim 11, wherein the specification prose is factual attributes of the item collected from inspectors or the manufacturers database, and the specification prose records are immutable and used to identify the item through descriptive attributes, specifications, and identifications; and wherein the specification prose includes item-id, item-metadata TLVs (Type/Length/Value); and wherein the item-id includes PUF, that is the built-in electronic identifier stored on SOC secure enclaves and PCF, serial number; and wherein the item-metadata TLVs includes photo, 3D model, description; and wherein the discretionary prose are the attributes elected at the discretion of the owner; and wherein the discretionary prose includes owner-id, mutable TLVs, 3-way mutable TLVs and immutable TLVs; and wherein the mutable TLVs (Type/Length/Value) is muted by the current or future owners of the digital surrogate; and wherein the 3-way mutable TLVs is muted by the current and future owner only with approval from the first owner of the item; and wherein the immutable TLVs is set by the first owner and is not altered, changed, or deleted by any future owner.

13. The system (200) according to claim 11, wherein the system (200) uses the mapping of NFT or digital surrogate to the original asset through PUF or PCF, enables to identify authentic goods during the transaction time and make sure the counterfeit real-world asset can be identified by all parties prior to finalizing a transaction.

14. The system (200) according to claim 11, wherein the real-world asset once sold to a new owner, then the associated ownership of the digital surrogate is also transferred to the new owner; and wherein the transfer of ownership of the digital surrogate to the new owner is processed through an application, website or a phone call; and wherein the transfer of ownership to the new owner will mutate the current owner of the assets without affecting immutable records of the first owner of the real-world asset or deleting any prior ownership records.

15. The system (200) according to claim 11, wherein the changes in ownership of the real-world asset is validated via changes in ownership of the digital surrogate; and wherein the changes in ownership of the real-world asset is associated with the changes in ownership of the digital surrogate in an immutable form in the secure distributed ledger.

16. The system (200) according to claim 11, wherein the transfer of ownership and validation of ownership of the digital surrogate is achieved through a digital surrogate validation application platform; and wherein the creation of the digital surrogate is achieved through a digital surrogate identity platform; and wherein the digital surrogate identity platform uses a combination of a unique identifier on the physical goods, manufacturer's details, the owner's identification data, and cryptography to create the digital surrogate; and wherein the digital surrogate validation application platform enables differentiating and validating the original asset from a counterfeit real-world asset; and wherein the digital surrogate identity platform and the digital surrogate validation application platform together constitutes a digital surrogate validation platform.

17. The system (200) according to claim 11, further configured to retain the record of all registered digital surrogate, which represent physical assets for validation and transfer of ownership.

18. The system (200) according to claim 11, further configured to enable the owner of an asset, a potential buyer, a manufacturer, or a law enforcement agency to look up the existence of the associated digital surrogate, by querying the physical item, PUF/PCF to establish originality and ownership.

19. The system (200) according to claim 11, wherein the associating specific immutable records including message, label, name to a digital surrogate enables the owner of the real-world asset to provide all identification information needed to create the digital surrogate or NFT along with a real validation of the originality of the asset by a certifying body.

20. The system (200) according to claim 11, wherein the system (200) is further configured to modify mutable records associated with the ownership records based on immutable constrained populated by different members of the ownership chain.
